(19) United States
(12) Patent Application Publication
(10) Pub. No.: US 2026/0261142 A1
(43) Pub. Date: Sep. 3, 2026

(54) SYSTEMS, METHODS, AND STORAGE MEDIA FOR FAST PREDICTION OF FREQUENCY AND VOLTAGE DYNAMICS IN POWER GRIDS AND ASSESSING NETWORK STABILITY

(71) Applicants: The Regents of the University of Colorado, a body corporate, Denver, CO (US); Alliance for Energy Innovation, LLC, Golden, CO (US)

(72) Inventors: Marena Trujillo, Westminster, CO (US); Amir Sajadi, San Diego, CA (US); Bri-Mathias S. Hodge, Golden, CO (US); Jonathan Shaw, Boulder, CO (US)

(21) Appl. No.: 19/552,762

(22) Filed: Feb. 27, 2026

Related U.S. Application Data
(60) Provisional application No. 63/765,221, filed on Feb. 28, 2025.

(51) Int. Cl. H02J 13/12; G05B 17/02; H02J 3/38; H02J 103/35

(52) U.S. Cl. CPC H02J 13/12; G05B 17/02; H02J 3/38; H02J 2103/35

(57) ABSTRACT

A method is for monitoring a power grid system and includes receiving network topology data and operating data of power generators and loads in the power grid system comprising a plurality of inverter-based resources operating in a grid-forming mode, to form a reduced susceptance matrix and a disturbance injection matrix, forming a frequency model to predict frequency dynamics across the plurality of inverter-based resources based on the reduced susceptance matrix and the disturbance injection matrix, forming a voltage model to track a change in a reactive power injection based on an AC power flow, and solving the frequency model and the voltage model to predict a power injection at a generator node of each inverter-based resource due to a disturbance. The frequency model and the voltage model are solved independently to produce time-domain frequency and voltage trajectories.

### CROSS-REFERENCE TO RELATED APPLICATIONS

This application claims the benefit of and priority to U.S. Provisional Patent Application Ser. No. 63/765,221 filed on Feb. 28, 2025, and entitled “Systems, Methods, and Storage Media for Fast Prediction of Frequency and Voltage Dynamics in Power Grids and Assessing Network Stability,” which is expressly incorporated herein by reference in its entirety.

### GOVERNMENT RIGHTS

This invention was made with government support under grant number DGE2040434, awarded by the National Science Foundation. The government has certain rights in the invention.

### FIELD

The present disclosure relates generally to electric power system modeling and analysis, and more particularly to reduced-order analytical modeling of frequency and voltage dynamics in inverter-dominated electric power networks. The disclosure further relates to computer-implemented methods and systems for fast simulation, planning, and operational assessment of large-scale power systems comprising grid-forming inverter-based resources.

### BACKGROUND

Electric power systems have historically been designed and analyzed under the assumption that synchronous generators are the primary sources of electrical power generation. Under this paradigm, system frequency dynamics are governed by mechanical inertia and governor response, while voltage regulation is managed locally by automatic voltage regulators operating on faster electromagnetic timescales. As a result, analytical and reduced-order models developed for power system planning and operation have largely focused on aggregate system frequency behavior, often assuming that frequency is homogeneous across the network and that voltage magnitudes remain approximately constant at nominal values. These assumptions have enabled tractable modeling approaches but have been fundamentally tied to the physical characteristics of synchronous machine-dominated grids.

The increasing penetration of inverter-based resources, including wind, solar, and battery energy storage systems, has significantly altered the dynamic behavior of modern power systems. Grid-forming inverters, in particular, generate frequency and regulate voltage through control algorithms rather than mechanical inertia, resulting in faster, predominantly electromagnetic dynamics. In inverter-dominated systems, frequency response is no longer well described by second-order swing equations, and voltage and frequency dynamics may occur on comparable timescales. Moreover, network topology and electrical distance play a critical role in disturbance propagation, leading to spatially heterogeneous frequency responses across the system. Existing system frequency response models typically neglect these spatial effects, systematically underestimating key metrics such as frequency nadir and rate of change of frequency, and provide little or no insight into nodal voltage behavior following disturbances.

While electromagnetic transient (EMT) simulation tools can capture these dynamics with high fidelity, their computational burden renders them impractical for large-scale systems or for applications requiring rapid evaluation, such as contingency screening or real-time operational assessment. Conversely, conventional reduced-order and positive-sequence models lack the ability to accurately represent inverter control behavior, post-disturbance reactive power redistribution, and voltage-angle coupling. In particular, existing reduced-order models either ignore voltage dynamics altogether or require additional state variables that severely limit scalability. Accordingly, there is a need for computationally efficient analytical models capable of accurately estimating both frequency and voltage response at individual inverter nodes in large-scale, inverter-dominated power systems, while preserving key physical phenomena associated with network topology and inverter control.

### BRIEF SUMMARY

Disclosed embodiments include an analytic models of frequency and voltage in large-scale all-inverter power systems. The analytic models are provided to solve dynamic problems due to introduction of various renewable power generators, which have lower inertia than conventional synchronous power generators and operate in a grid-forming mode. Based on the analytic models, the computation burdens can be lightened and the computational speed can be faster than the full electromagnetic transient (EMT) simulation tools in several magnitudes for large-scale or real time operational analysis. Differently put, the disclosed embodiments enable rapid disturbance assessment and dynamic response evaluation while monitoring inverter-dominated power systems, including large-scale networks comprising hundreds or thousands of grid-forming inverters.

According to various aspects, a method for monitoring a power grid system includes receiving network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix, forming a frequency model to predict frequency dynamics across the plurality of inverter-based resources based on the reduced susceptance matrix and the disturbance injection matrix, forming a voltage model to track a change in a reactive power injection based on the reduced susceptance matrix and an angle of voltages at the plurality of inverter-based resources, and solving the frequency model and the voltage model to predict a power injection at a generator node of each inverter-based resource due to a disturbance. The frequency model and the voltage model are solved independently to produce time-domain frequency and voltage trajectories for each inverter-based resource

According to various aspects, a grid monitoring system is for fast and dynamic simulation of a power grid system. The grid monitoring system includes one or more processors, and a memory storing instructions that, when executed by the one or more processors, cause the grid monitoring system to: receive network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix, form a frequency model to predict frequency dynamics across the plurality of inverter-based resources based on the reduced susceptance matrix and the disturbance injection matrix, form a voltage model to track a change in a reactive power injection based on the reduced susceptance matrix and an angle of voltages at the plurality of inverter-based resources, and solve the frequency model and the voltage model to predict a power injection at a generator node of each inverter-based resource due to a disturbance. The frequency model and the voltage model are solved independently to produce time-domain frequency and voltage trajectories for each inverter-based resource.

According to various aspects, a non-transitory computer-readable medium storing instructions that, when executed by one or more processors, cause the one or more processors to perform a method for monitoring a power grid system. The method includes receiving network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix; forming a frequency model to predict frequency dynamics across the plurality of inverter-based resources based on the reduced susceptance matrix and the disturbance injection matrix; forming a voltage model to track a change in a reactive power injection based on an AC power flow; and solving the frequency model and the voltage model to predict a power injection at a generator node of each inverter-based resource due to a disturbance. The frequency model and the voltage model are solved independently to produce time-domain frequency and voltage trajectories for each inverter-based resource.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which at least some of the advantages and features of the present disclosure may be obtained, a more particular description of aspects of the present disclosure will be rendered by reference to specific aspects thereof which are illustrated in the appended drawings. Understanding that these drawings depict only typical aspects of the present disclosure and are not therefore to be considered to be limiting of its scope, aspects of the present disclosure will be described and explained with additional specificity and detail through the use of the accompanying drawings.

FIG. 1 illustrates a power grid system according to various aspects of the present disclosure.

FIGS. 2A and 2B illustrate frequency response curves for a conventional power generator and a grid-forming inverter, respectively, according to various aspects of the present disclosure.

FIG. 3A illustrates a graphical relationship between reactive voltage and active voltage based on a phase difference according to various aspects of the present disclosure.

FIG. 3B illustrates a reactive voltage surface as active voltage and a phase difference change according to various aspects of the present disclosure.

FIG. 4 illustrates a block diagram for a reactive voltage droop control according to various aspects of the present disclosure.

FIG. 5 illustrates a flowchart of a monitoring method using frequency and voltage models according to various aspects of the present disclosure.

FIG. 6 illustrates a block diagram of a computing device according to various aspects of the present disclosure.

### DETAILED DESCRIPTION

The present disclosure provides systems and methods for predicting disturbance response in an electric power grid comprising a plurality of inverter-based resources operating in a grid-forming mode. In contrast to conventional power system models that rely on synchronous generator inertia and assume homogeneous system frequency, the disclosed framework models frequency and voltage dynamics using reduced-order representations tailored to inverter-dominated networks. The system receives network topology data and operating parameters associated with generator nodes and load nodes, constructs a reduced network representation by eliminating non-generator nodes, and forms analytical models that capture active power-angle coupling and reactive power-voltage coupling in a scalable manner.

In particular, the disclosed method separates disturbance prediction into a frequency model and a voltage model. The frequency model represents droop-controlled grid-forming inverter dynamics in a linear state-space form driven by active power imbalance and a reduced susceptance matrix derived from the network topology. The voltage model represents reactive droop behavior driven by post-disturbance reactive power redistribution determined through an AC power flow update. By solving the frequency and voltage models independently using analytical techniques, such as matrix exponential solutions, the system produces time-domain nodal frequency and voltage trajectories while significantly reducing computational burden compared to full electromagnetic transient simulations.

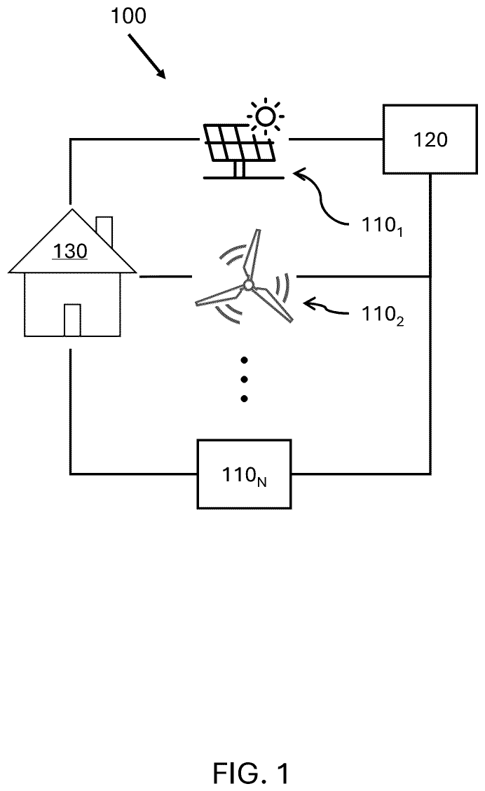

Referring now to FIG. 1, illustrated is an example of an inverter-based resource (IBR) dominated power grid system 100. The system 100 may include a plurality of inverter-based resources (IBRs) 110, one or more loads 130, and a monitoring system 120 configured to perform disturbance response prediction and dynamic assessment.

The plurality of inverter-based resources 110 may include, for example, solar photovoltaic systems 1101, wind turbine systems 1102, battery energy storage systems, or other power electronic interfaced generation resources operating in a grid-forming mode. Each IBR 110 may be configured to inject active and reactive power into the power grid system 100 and to regulate at least one of voltage magnitude or frequency according to a droop-based control scheme. The IBRs 110 may be electrically coupled through a transmission or distribution network, which may include buses, transmission lines, and other interconnection components.

The loads 130 represent electrical demand devices connected to the power grid system 100, such as residential, commercial, or industrial loads. The loads 130 may consume active power, reactive power, or both, and may be geographically distributed across the distribution network. Disturbances in the system 100 may arise from changes in load demand, disconnection from an IBR 110, or other network events.

The monitoring system 120 may be communicatively coupled to the IBRs 110 and configured to receive network topology data and operating data associated with the IBRs 110 and the loads 130. In various aspects, the monitoring system 120 may include one or more processors and memory storing instructions to construct reduced network models, form frequency and voltage models, and compute time-domain nodal frequency and voltage trajectories following a disturbance. The monitoring system 120 may operate in real time or near real time to provide dynamic security assessment, contingency screening, or predictive stability analysis for the IBR-dominated power grid system 100.

In operation, the monitoring system 120 may receive measurements or state estimates corresponding to operating conditions of the IBRs 110 and loads 130, form a reduced network representation, and predict disturbance-induced frequency and voltage responses at the generator nodes associated with the IBRs 110. In an aspect, the monitoring system 120 may generate a control signal based on trajectories of the frequency dynamics and the change in the reactive power injection to adjust values of the operating data of power generations associated with the IBRs 100.

In various aspects, the monitoring system 120 may generate one or more control signals based on the predicted frequency and voltage trajectories. The monitoring system 120 may compare predicted frequency deviation, rate of change of frequency, or voltage magnitude against predefined stability thresholds. If a threshold violation is predicted, the monitoring system 120 determines corrective adjustments to one or more operating parameters of at least one inverter-based resource. Such adjustments may include modification of droop gain values, active power setpoints, reactive power setpoints, voltage magnitude references, or current limits. The control signal is transmitted to inverter controllers to modify operating data in real time to mitigate the disturbance and maintain network stability. In some embodiments, the system iteratively recomputes disturbance response following parameter adjustment until predicted stability criteria are satisfied.

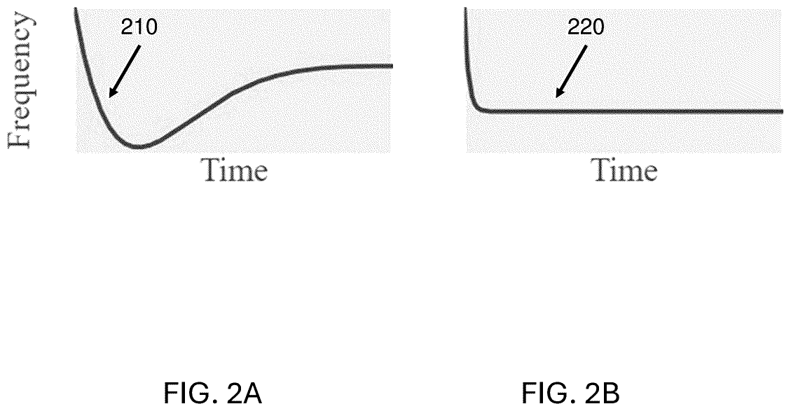

Referring now to FIGS. 2A and 2B, illustrated are graphical comparisons between frequency response characteristics of a conventional synchronous generator system and a grid-forming inverter system (e.g., the IBR-dominated power grid system 100 of FIG. 1). Specifically, FIG. 2A illustrates a representative frequency response curve 210 and FIG. 2B illustrates a representative frequency response curve 220. The frequency response curves 210 and 220 are plotted with frequency in the vertical axis and time in the horizontal axis.

The frequency response curve 210 corresponds to a synchronous generator-based system. The frequency response curve 210 illustrates a gradual frequency decline following an active power disturbance, characterized by an initial inertial phase and a subsequent recovery phase governed by turbine-governor control. Because synchronous generators possess physical rotational inertia, the initial rate of change of frequency (RoCoF) is limited by stored kinetic energy in the rotating mass of the turbine. The response curve 210 thus exhibits a relatively smooth and rounded nadir, followed by a controlled recovery toward steady-state frequency.

In contrast, the frequency response curve 220 corresponding to a grid-forming inverter-based system demonstrates a more abrupt change in frequency following a disturbance. Unlike the frequency response curve 210 of the synchronous generator, the frequency response curve 220 of inverter-based resources lacks a mechanically governed inertial phase. Instead, frequency behavior is dictated by control parameters, such as droop gain and measurement filtering time constants implemented in the inverter control loop. As a result, the frequency deviation in curve 220 may exhibit a sharper initial slope and a control-dominated first-order response profile.

The contrast between curves 210 and 220 shows a fundamental difference in disturbance response behavior between inertia-dominated synchronous generator systems and control-dominated inverter-based resource systems. In particular, the absence of mechanical inertia in grid-forming inverter systems necessitates analytical modeling techniques that directly incorporate droop-based control dynamics and network-coupled active power redistribution, as further described herein.

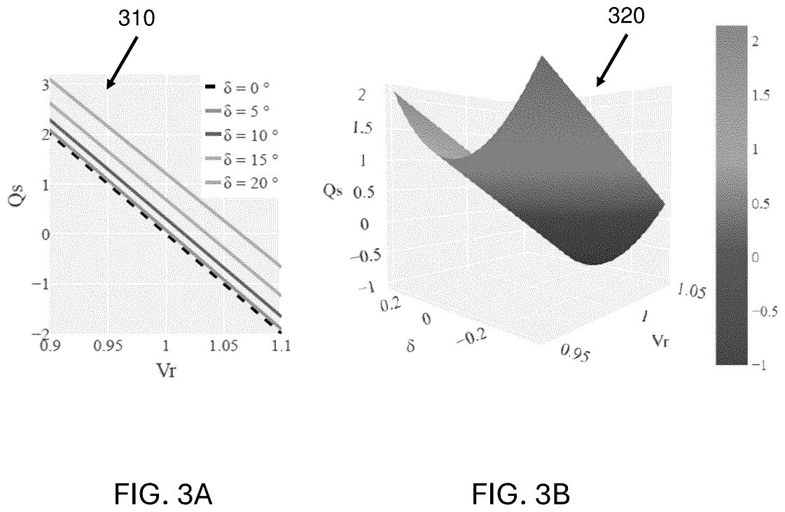

Referring now to FIGS. 3A and 3B, illustrated are the relationships between reactive power and phase angle difference in an inverter-dominated power grid system. FIG. 3A illustrates two-dimensional curves 310 of reactive power Qₛ as a function of voltage magnitude V_{R} for multiple fixed phase angle differences δ. As such, the curves 310 are present with the voltage magnitude in the horizontal axis and the reactive power in the vertical axis. Each curve 310 corresponds to a different value of phase angle differences δ, including δ=0°, 5°, 10°, 15°, and 20°.

The dashed curve represents the case where δ=0°, which corresponds to the small-angle approximation commonly assumed in simplified power flow formulations. Under this approximation, reactive power is primarily a function of voltage magnitude. However, as the phase angle difference increases, the corresponding curves deviate from the dashed curve, demonstrating that reactive power varies significantly with the angle even when voltage magnitude is unchanged.

Thus, reactive power and active power are indirectly coupled through the phase angle difference between buses. In particular, an active power disturbance that increases angle separation produces a corresponding change in reactive power injection. This Q-δ coupling effect may be accounted for in the disclosed voltage modeling approach by computing post-disturbance reactive injections based on updated voltage magnitudes and phase angles as detailed in the following.

FIG. 3B illustrates a three-dimensional surface 320 representing reactive power Qₛ at a sending-end bus as a function of receiving-end voltage magnitude V_{R} and phase angle difference δ between interconnected buses. The surface 320 demonstrates that reactive power is jointly dependent on both voltage magnitude and phase angle difference.

As illustrated in FIG. 3B, variations in the phase angle difference Salter the reactive power injection even when voltage magnitude remains substantially constant. Conversely, changes in voltage magnitude also influence reactive power for a given angle difference. The non-planar nature of the surface 320 indicates that reactive power is not linearly separable from phase angle effects. Accordingly, changes in active power that modify phase angle separation across the network inherently induce changes in reactive power injection.

This relationship is particularly relevant in grid-forming inverter systems, where active power disturbances lead to changes in bus voltage angles. The angle-dependent reactive power variation illustrated by the surface 320 is incorporated in reactive power computation in the voltage model as detailed in the following.

Thus, FIGS. 3A and 3B together illustrate that reactive power injection at generator nodes depends not only on local voltage magnitude but also on network angle differences that arise from active power redistribution. In the inverter-dominated power grid system as disclosed in the present disclosure, the frequency model determines post-disturbance voltage angle trajectories, and the voltage model subsequently computes reactive power changes based on those angle variations. The angle-dependent reactive power relationship illustrated in FIGS. 3A and 3B therefore supports the need for sequential frequency and voltage modeling rather than purely decoupled approximations.

The frequency model may provide a reduced-order analytical representation of frequency dynamics in a power grid system, which includes a plurality of grid-forming inverters. In inverter-dominated systems, frequency is not governed by mechanical inertia as in synchronous generators, but instead is determined by droop-based control algorithms implemented in power electronic converters. In this regard, the following frequency model may represent inverter frequency behavior using first-order control dynamics coupled through a reduced network representation of active power flow.

In various aspects, each grid-forming inverter may be modeled using a droop-based frequency deviation equation of the form:

$$Δ \dot{δ} = {ω}_{0} Δω , and \qquad ( 1 )$$

$$Δ \dot{ω} = \frac{1}{{T}_{c}} ( R Δ {P}_{e} - Δω ) , \qquad ( 2 )$$

where Δδ denotes voltage angle deviation, Δω denotes frequency deviation, ω₀ is nominal angular frequency, R is the droop gain parameter, T_{C} is the power measurement time constant, and ΔPₑ represents the electrical active power imbalance at the inverter.

Equation (1) establishes that voltage angle deviation evolves as the time integral of frequency deviation, and Equation (2) represents that frequency deviation is adjusted proportionally to active power imbalance through a filtered droop control loop.

To couple the inverter frequency dynamics across the network, a linearized DC power flow formulation may be used to model active power redistribution. Under the DC approximation assumptions, active power injection at bus k may be given by:

$${P}_{k} = {\sum }_{j = 1 , j \neq k}^{N} {B}_{k j} ( {θ}_{k} - {θ}_{j} ) , \qquad ( 3 )$$

where Bₖⱼ represents susceptance elements of the network matrix and θₖ represents bus voltage angles. In vector form, the active power relationship may be written as:

$$Δ P = B Δθ , \qquad ( 4 )$$

where ΔP is the vector of active power injection deviations, B is the susceptance matrix, and Δθ is the vector of voltage angle deviations.

The network is partitioned into generator nodes G and load nodes L, yielding:

$$[ \begin{matrix}Δ {P}_{G} \\ Δ {P}_{L}\end{matrix} ] = [ \begin{matrix}{B}_{G G} & {B}_{G L} \\ {B}_{L G} & {B}_{L L}\end{matrix} ] [ \begin{matrix}Δ {θ}_{G} \\ Δ {θ}_{L}\end{matrix} ] , \qquad ( 5 )$$

where ΔP_{G} denotes active power deviations at generator nodes, ΔP_{L} denotes active power deviations at load nodes, and B_{GG}, B_{GL}, B_{LG}, and B_{LL} are partitions of the full susceptance matrix. Load nodes are eliminated through network reduction (e.g., Kron reduction), yielding:

$$Δ {P}_{G} = {B}_{r e d} Δ {θ}_{G} + {B}_{L} Δ {P}_{L} , \qquad ( 6 )$$

where:

$${B}_{r e d} = {B}_{G G} - {B}_{G L} {B}_{L L}^{- 1} {B}_{L G} , and \qquad ( 7 )$$

$${B}_{L} = {B}_{G L} {B}_{L L}^{- 1} . \qquad ( 8 )$$

The term B_{red}Δθ_{G} represents inter-generator active power coupling, and B_{L}ΔP_{L} represents a disturbance injection projected onto generator nodes. The term “disturbance injection matrix” refers to a matrix derived from partitioned susceptance submatrices that maps load-side power disturbances to generator nodes. Specifically, after partitioning the susceptance matrix into generator-node and load-node components and eliminating load-node variables, a mapping matrix

$${B}_{L} = {B}_{G L} {B}_{L L}^{- 1}$$

is obtained. Ine disturbance injection matrix B_{L} therefore represents the structural distribution of active power imbalance across generator nodes based on network topology. The load power deviation ΔP a is projected onto generator nodes based on network topology.

$$Δ {P}_{d} = {B}_{L} Δ {P}_{L} . \qquad ( 9 )$$

For a system comprising N_{G} grid-forming inverters, relative angle variables are defined to remove one redundant angle reference, resulting in 2N_{G}−1 state variables. The compact state-space formulation of the frequency model may be expressed as:

$$[ \begin{matrix}Δ {\dot{δ}}_{i , n - 1} \\ Δ \dot{{ω}_{i}}\end{matrix} ] = \underbrace{[ \begin{matrix}0 & {1}_{- 1} \\ {B}_{n} & {T}_{n}\end{matrix} ]}_{{A}_{f}} [ \begin{matrix}Δ {\dot{δ}}_{i , n - 1} \\ Δ \dot{{ω}_{i}}\end{matrix} ] + \underbrace{[ \begin{matrix}0 \\ {γ}_{n}\end{matrix} ]}_{{B}_{f}} [ Δ {P}_{d} ] , \qquad ( 10 )$$

$${B}_{n} = - diag ( \frac{{ω}_{0} {α}_{n} {R}_{n}}{{T}_{c , n}} ) {B}_{r e d}^{′} , \qquad ( 11 )$$

$${T}_{n} = - diag ( \frac{1}{{T}_{c , n}} ) , and \qquad ( 12 )$$

$${γ}_{n} = diag ( \frac{{ω}_{0} {α}_{n} {R}_{n}}{{T}_{c , n}} ) , \qquad ( 13 )$$

where αₙ represents base-power scaling

$${B}_{r e d}^{′}$$

is the reduced susceptance matrix B_{red} with one reference column removed, A_{f} is the frequency system matrix, and B_{f} is the disturbance input matrix. The angles in Equation (10) are relative angles Δδ₁ₙ, . . . Δδ_{n-1,n.}.

Equations (1)-(13) collectively define a linear, reduced-order, network-coupled frequency model. The equations (1) and (2) define the droop control dynamics and determine local inverter frequency behavior, while Equations (3)-(13) introduce network-dependent active power redistribution. In particular, Equations (10)-(13) assemble the coupled system into state-space form, enabling analytical time-domain solution via matrix exponential methods.

These equations also capture active power-angle coupling, droop-controlled inverter frequency dynamics, spatial heterogeneity in frequency response, and disturbance injection distribution across generator nodes. Unlike the conventional system frequency response models, this frequency model may be able to predict nodal frequency trajectories across the plurality of grid-forming inverters.

Substituting the reduced active power relationship into the droop-based frequency equation may yield a coupled system of differential equations governing the collective dynamics of all grid-forming inverters. For a system comprising N_{G} generator nodes, relative angle variables may be defined with respect to a selected reference generator node to eliminate redundant degrees of freedom. The resulting state vector may be defined as:

$$x = [ \begin{matrix}Δδ \\ Δω\end{matrix} ] , \qquad ( 14 )$$

where Δδ denotes relative voltage angle deviations and Δω denotes frequency deviations for the plurality of grid-forming inverters.

In an aspect, the coupled frequency dynamics may be expressed in linear state-space form as:

$$\dot{x} = {A}_{f} x + {B}_{f} Δ {P}_{d} , \qquad ( 15 )$$

where A_{f} is a system matrix incorporating droop gains, measurement time constants, and reduced network susceptance terms, and B_{f} is an input matrix mapping disturbance injections to generator nodes. More specifically, the system matrix A_{f} includes diagonal elements corresponding to first-order droop control dynamics and off-diagonal elements derived from the reduced susceptance matrix B_{red}. The reduced susceptance matrix introduces coupling between generator nodes, thereby enabling prediction of spatially heterogeneous frequency response across the network.

Because the resulting system is linear and time-invariant under small-signal assumptions, the time-domain solution may be expressed analytically using a matrix exponential:

$$x ( t ) = {\int }_{0}^{t} {e}^{- {A}_{f} τ} κ d τ , and \qquad ( 16 )$$

$$κ = {B}_{f} Δ {P}_{d} . \qquad ( 17 )$$

For step disturbances and zero initial deviation, the solution simplifies to:

$$x ( t ) = {A}_{f}^{- 1} ( 1 - {e}^{{A}_{f} t} ) {B}_{f} Δ {P}_{d} . \qquad ( 18 )$$

The analytical matrix exponential solution eliminates iterative time-stepping procedures, thereby enabling rapid evaluation of large-scale inverter-dominated networks comprising hundreds or thousands of generator nodes. This computational improvement permits real-time or near real-time dynamic security assessment not achievable using conventional EMT-based approaches.

Thus, the frequency model can capture droop-controlled inverter dynamics, active power-angle coupling through a reduced network representation, spatial heterogeneity of frequency response, and disturbance-driven active power redistribution, while maintaining reduced computational complexity suitable for large-scale inverter-dominated power grids.

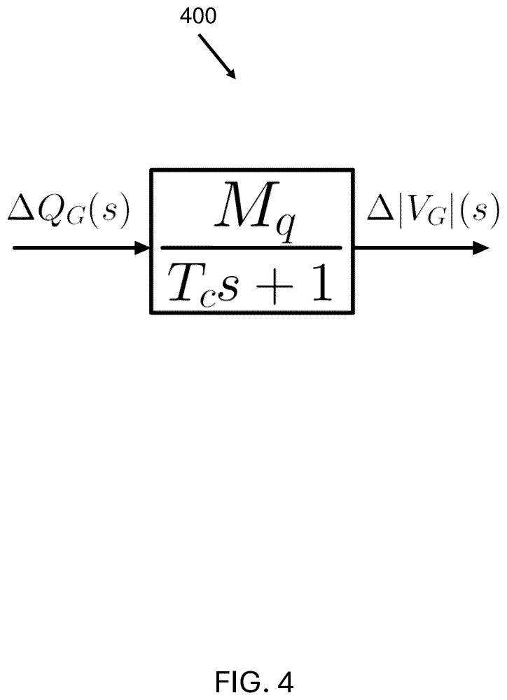

Now turning to FIG. 4, illustrated is a schematic diagram for a reduced-order reactive droop control model for a grid-forming inverter, which forms the basis of a voltage model 400. The voltage model 400 may represent the dynamic response of voltage magnitude at generator nodes as a function of reactive power imbalance ΔQ_{G}(s). Unlike the frequency model, which relies on DC power flow approximation, the voltage model 400 may incorporate AC power flow relations and Q-δ coupling. Together, the frequency model and voltage model 400 provide complementary representations of active power frequency dynamics and reactive power voltage dynamics in inverter-dominated power systems.

Further, unlike synchronous generators, where voltage magnitude is regulated by an automatic voltage regulator (AVR) and excitation system, grid-forming inverters regulate voltage through droop-based control implemented in power electronic converters. The voltage model 400 may be expressed as a first-order reactive droop structure. The reactive power deviation ΔQ_{G} is processed through a droop gain M_{q} and a first-order filter having a time constant T_{c}.

Based on the Laplace transformation, the voltage model 400 may correspond to the following transfer function:

$$Δ {V}_{G} ( s ) = \frac{{M}_{q}}{{T}_{c} s + 1} Δ {Q}_{G} ( s ) , \qquad ( 19 )$$

where ΔQ_{G} represents the change in reactive power injection at a generator node, M_{q} represents the reactive droop gain, T_{c} denotes a control time constant, and ΔV_{G} denotes the resulting change in inverter voltage magnitude.

Converting to the time domain yields the first-order differential equation:

$${T}_{c} Δ {\dot{V}}_{G} + Δ {V}_{G} = {M}_{q} Δ {Q}_{G} , \qquad ( 20 )$$

which may be rearranged as:

$$Δ {\dot{V}}_{G} = - \frac{1}{{T}_{c}} Δ {V}_{G} + \frac{{M}_{q}}{{T}_{c}} Δ {Q}_{G} . \qquad ( 20 ’ )$$

These equations show that voltage magnitude deviation evolves proportionally to reactive power imbalance while being filtered through a first-order dynamic response.

The reactive power change ΔQ_{G} driving the voltage model 400 is obtained from the AC power flow relationship. The instantaneous reactive power injection at bus i is given by:

$${Q}_{i} = - {\sum }_{j = 1}^{n} {B}_{i j} {V}_{i} {V}_{j} cos ( {θ}_{i j} ) + {\sum }_{j = 1}^{n} {G}_{i j} {V}_{i} {V}_{j} sin ( {θ}_{i j} ) , \qquad ( 21 )$$

where Vᵢ and Vⱼ denote voltage magnitudes, θᵢⱼ=θᵢ−θⱼ denotes phase angle difference, and Bᵢⱼ and Gᵢⱼ are susceptance and conductance elements of the network admittance matrix.

The reactive power injection at each generator node is a nonlinear function of both voltage magnitude and phase angle difference, as expressed in Equation (21). Thus, changes in phase angle θ induced by active power disturbances inherently produce changes in reactive power injection. The voltage model incorporates this Q-d coupling by computing post-disturbance reactive injection using updated angle values obtained from the frequency model.

Following a disturbance, updated voltage angles and active power injections may be obtained from the frequency model. An AC power flow may be then solved to determine post-disturbance reactive injections. The reactive power deviation at each generator node is computed as:

$$Δ {Q}_{G} = {Q}_{G} ( {V}_{post} , {θ}_{post} ) - {Q}_{G 0} , \qquad ( 22 )$$

where Q_{G} (Vₚₒₛₜ, θₚₒₛₜ) represents post-disturbance reactive injection, and Q_{G0} represents pre-disturbance reactive setpoint. Equation (22) shows the dependence of reactive power on both voltage magnitude and phase angle, thereby incorporating Q-δ coupling effects illustrated in FIGS. 3A and 3B.

Practically, inner-loop voltage and current controllers, coordinate transformations, and filter dynamics influence the relationship between droop-controlled voltage and terminal grid voltage. To preserve reduced-order structure while accounting for these effects, a voltage outer-loop-to-grid scaling constant Kᵥ may be introduced such that:

$$Δ {V}_{G , g r i d} \approx {K}_{v} Δ {V}_{G} . \qquad ( 23 )$$

This approximation aggregates inner-loop dynamics into a single proportional mapping, thereby maintaining computational tractability.

The voltage model 400 may be formulated independently of the frequency state-space matrix for the frequency model. In particular, the voltage model 400 may employ a separate state matrix Aᵥ and input matrix Bᵥ, each derived from reactive droop parameters and voltage control time constants. The reduced susceptance matrix influences the voltage model indirectly through updated phase angle values obtained from the frequency model and subsequent AC power flow calculations.

The voltage dynamics across N_{G} are stacked at generator nodes, yielding the following vector state-space form:

$$Δ \vert {\dot{V}}_{G} \vert = {A}_{v} Δ \vert {V}_{G} \vert + {B}_{v} Δ {Q}_{G} , and \qquad ( 24 )$$

$${A}_{v} = - diag ( \frac{1}{{T}_{c , n}} ) , {B}_{v} = diag ( \frac{{α}_{n} {M}_{q , n} {K}_{v} {L}^{n}}{{T}_{c , n}} ) , \qquad ( 25 )$$

where Aᵥ is a diagonal matrix representing local first-order voltage decay, Bᵥ is a diagonal matrix representing reactive droop sensitivity, and an is a per-unit scaling factor. Since the matrix Aᵥ is diagonal and stable (assuming negative diagonal entries), the voltage response may be solved analytically using a matrix exponential solution similar to the frequency model.

Specifically, since the resulting system is linear and time-invariant under small-signal assumptions, the time-domain solution may be expressed analytically using a matrix exponential:

$$x ( t ) = {\int }_{0}^{t} {e}^{- {A}_{v} τ} κ d τ , and \qquad ( 26 )$$

$$κ = {B}_{v} Δ {Q}_{G} . \qquad ( 27 )$$

For step disturbances and zero initial deviation, the solution simplifies to:

$$x ( t ) = {A}_{v}^{- 1} ( 1 - {e}^{{A}_{v} t} ) {B}_{v} Δ {Q}_{G} . \qquad ( 22 )$$

This analytical solution enables direct computation of voltage and reactive power trajectories without requiring iterative time-stepping simulation, thereby reducing the computation power by several magnitudes and increasing the computation speed by several magnitudes.

According to the frequency and voltage models, disturbance-induced changes in active and reactive power injection are predicted at each generator node in addition to predicting time-domain frequency and voltage trajectories. Specifically, the frequency model determines updated active power injections ΔP_{G}(t) resulting from angle deviations, and the voltage model determines updated reactive power injections ΔQ_{G}(t) based on post-disturbance AC power flow calculations. These predicted injection values may be used for stability assessment and control decision-making.

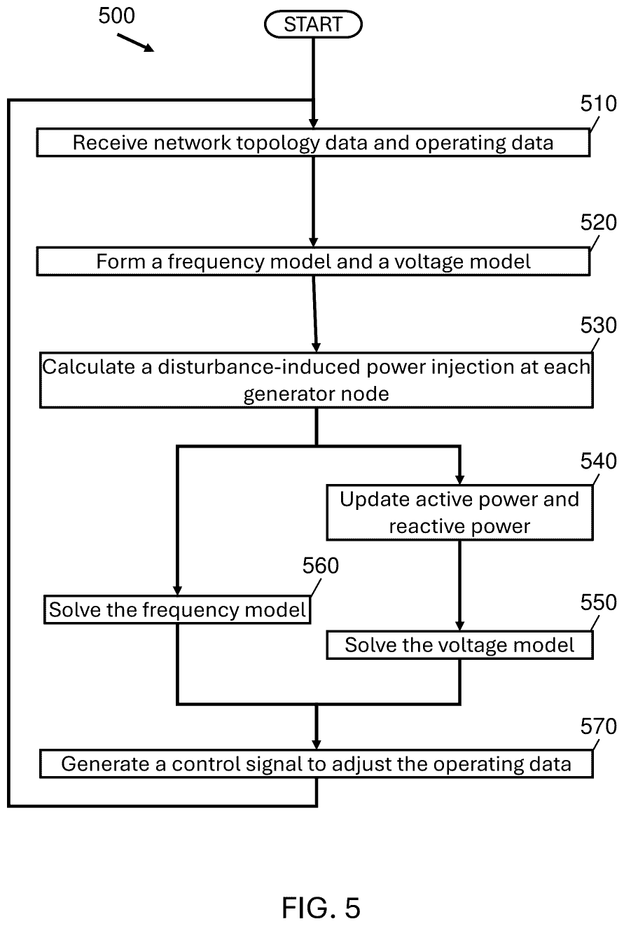

Referring now to FIG. 5, illustrated is a flowchart showing a monitoring method 500 for predicting disturbance response and optionally generating corrective control actions in an inverter-dominated power grid system according to various aspects of the present disclosure. The method 500 may be implemented by, for example, the monitoring system 120 of FIG. 1 and performs reduced-order dynamic modeling of grid-forming inverters.

The method 500 begins at a start block, indicating initiation of a disturbance prediction cycle. The cycle may be triggered periodically, in real time, or in response to detection of a disturbance event.

At step 510, the method 500 may be executed by receiving network topology data and operating data of the grid system. The network topology data may include generator nodes, load nodes, and line parameters. The operating data may include active power injections, reactive power injections, voltage magnitudes, voltage angles, droop gains, and measurement time constants associated with the grid-forming inverters of the grid system.

The method 500 may be further executed by, based on the received data, forming both a frequency model and a voltage model. Specifically, at step 520, the frequency model may be constructed by partitioning generator and load nodes, eliminating non-generator nodes to form a reduced susceptance matrix, and formulating droop-based inverter frequency dynamics in linear state-space form. Further, at step 520, the voltage model may be constructed by establishing reactive droop dynamics, incorporating AC power flow relationships for reactive power computation, and preparing a state-space representation for voltage magnitude evolution.

In various aspects, the frequency model and the voltage model may be formulated as separate linear state-space systems. The frequency model governs voltage angle and frequency deviations as functions of active power imbalance, while the voltage model governs voltage magnitude deviations as functions of reactive power imbalance. Although the two models are structurally independent and may be solved independently using analytical solutions, they are sequentially coupled through updates to active and reactive power injections. Thus, the frequency and voltage models may be mathematically independent but operationally coordinated.

Following model formations at step 520, the method 500 may be further executed by calculating a disturbance-induced power injection at each generator node at step 530. This includes computing an active power disturbance vector projected onto generator nodes using the reduced susceptance matrix. The active power imbalance serves as the input to the frequency model.

Based on preliminary frequency model outputs, the method 500 may be further executed by updating active power and reactive power values at generator nodes at step 540. Updated active power injections may be used to solve an AC power flow, which determines post-disturbance voltage magnitudes and angles. Using these updated values, reactive power changes at generator nodes may be calculated. By performing step 530, the Q-δ coupling between active power-induced angle shifts and reactive power redistribution may be captured.

The method 500 may be further executed by solving the frequency model to obtain time-domain trajectories of frequency deviation and voltage angle at each generator node at step 560. In one aspect, the solution may be obtained using an analytical matrix exponential representation of the linear state-space model. The output may include nodal frequency trajectories and corresponding angle trajectories.

The method 500 may be further executed by solving the voltage model using the computed reactive power changes as inputs at step 550. The voltage model may produce time-domain voltage magnitude trajectories at each generator node, also using a first-order state-space representation and, in other words, an analytical solution method.

In one aspect, the frequency and voltage models may be solved independently, although coupled sequentially through power updates.

In some aspects, the method 500 may be further executed by generating a control signal to adjust operating data based on the predicted trajectories. For example, if frequency deviation exceeds a threshold or voltage magnitude falls outside acceptable limits, a control command may be generated to modify droop gains, active power setpoints, reactive power setpoints, or voltage references of one or more grid-forming inverters. The control signal may be transmitted to inverter controllers to mitigate the disturbance and restore system stability.

In aspects, the method 500 or any other control modules may be performed by a computing device, server, tablet, or cloud server or implemented by one or modules or programs executed by one or more computing systems. Interconnection of computing systems may be facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a plurality of web based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

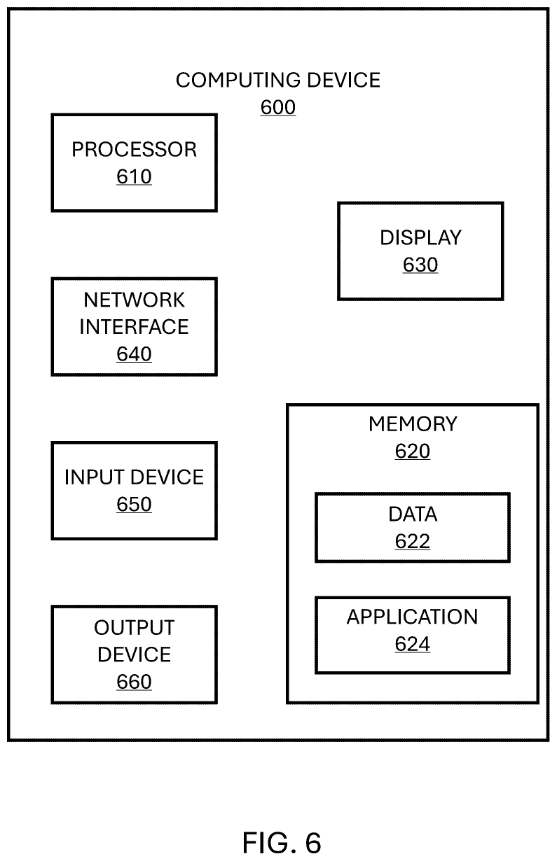

Turning now to FIG. 6, disclosed aspects may comprise or utilize a special purpose or general-purpose computing device 600 including computer hardware, as discussed in greater detail below. The computing device 600 may be a laptop or desktop computer, server, edge computer, or cloud computer, which can perform any functions, methods, processes disclosed above. The computing device 600 may include a processor 610, a memory 620, a display 630, a network interface 640, an input device 650, and/or an output device 660. The memory 620 includes any non-transitory computer-readable storage media for storing data and/or software that is executable by the processor 610 and which controls the operation of the computing device 600.

The computing device 600 may include an operating system configured to perform executable instructions. The operating system is, for example, software, including programs and data, which manages hardware of the disclosed apparatus and provides services for execution of applications for use with the disclosed apparatus. Those of skill in the art will recognize that suitable operating systems include, by way of non-limiting examples, FreeBSD®, OpenBSD, NetBSD®, Linux®, Unix®, Apple® Mac OS X Server®, Oracle® Solaris®, Windows Server®, Windows®, Novell®, NetWare®, iOS®, Android®, or any other operating system readily available. In some aspects, the operating system is provided by cloud computing.

The processor 610 may be a general purpose processor, a specialized graphics processing unit (GPU) configured to perform specific graphics processing tasks (e.g., parallel processing for training and testing grid data) while freeing up the general-purpose processor to perform other tasks, and/or any number or combination of such processors, digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

The memory 620 may include one or more solid-state storage devices such as flash memory chips. Alternatively or in addition to the one or more solid-state storage devices, the memory 620 may include one or more mass storage devices connected to the processor 610 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 610. That is, computer readable storage media may include non-transitory, volatile and non-volatile, removable and non-removable media implemented in any method or technology for storage of information such as computer-readable instructions, data structures, program modules or other data. For example, computer-readable storage media includes random access memory (RAM), read-only memory (ROM), erasable programmable read-only memory (EPROM), electrically erasable programmable read-only memory (EEPROM), flash memory or other solid state memory technology, compact disc read-only memory (CD-ROM), digital video disc (DVD), Blu-Ray or other optical storage, magnetic cassettes, magnetic tape, magnetic disk storage or other magnetic storage devices, or any other medium which can be used to store the desired information and which can be accessed by the computing device 600.

The memory 620 may store application 624 (e.g., grid monitoring module, AI algorithm, etc.) and/or data 622 (e.g., grid topological data and operation data). The application 624 may, when executed by processor 610, cause the display 630 to present the user interface to provide information to users. The application 624 may be one or more software programs stored in the memory 620 and executed by the processor 610 of the computing device 600. The application 624 may be installed directly on the computing device 600 or via the network interface 640. The application 624 may run natively on the computing device 600, as a web-based application, or any other format known to those skilled in the art.

In an aspect, the application 624 may include a sequence of process-executable instructions, which can perform any of the herein described methods, programs, algorithms or codes, which are converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C, Delphi, Fortran, Java, JavaScript, python, machine code, operating system command languages, Pascal, Perl, PL1, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The display 630 may be a cathode ray tube (CRT), a liquid crystal display (LCD), a thin film transistor liquid crystal display (TFT-LCD), and an organic light emitting diode (OLED) display. In certain aspects, the OLED display is a passive-matrix OLED (PMOLED) or active-matrix OLED (AMOLED) display. In aspects, the display 630 is a plasma display, and a video projector. In various aspects, the display 630 may be interactive (e.g., having a touch screen or a sensor such as a camera, a 3D sensor, etc.) that can detect user interactions/gestures/responses and the like so as to serve as both an input and output device.

The network interface 640 may be configured to connect to a network such as a local area network (LAN) consisting of a wired network and/or a wireless network, a wide area network (WAN), a wireless mobile network, a Bluetooth network, and/or the internet.

For example, the computing device 600 may process digital measurement data obtained from the multi-arm spiral antenna, through the network interface 640, to identify a direction of the transmission source of the signal. The computing device 600 may update the AI algorithm, for example, the application 624, via the network interface 640. The computing device 600 may also display processed results and any notification from training and/or testing on the display 630.

The input device 650 may be any device by means of which a user may interact with the computing device 600, such as, for example, a mouse, keyboard, touch screen, and/or any other interface. The output device 660 may include any connectivity port or bus, such as, for example, parallel ports, serial ports, universal serial busses (USB), or any other similar connectivity port known to those skilled in the art.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Computing system functionality can be enhanced by a computing system for ability to be interconnected to other computing systems and power generators via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

### Example Implementations

In view of the foregoing, the present disclosure relates, for example and without being limited thereto, to the following aspects:
Clause 1. A method for monitoring a power grid system includes receiving network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix; forming a frequency model to predict frequency dynamics across the plurality of inverter-based resources based on the reduced susceptance matrix and the disturbance injection matrix; forming a voltage model to track a change in a reactive power injection based on the reduced susceptance matrix and an angle of voltages at the plurality of inverter-based resources; and solving the frequency model and the voltage model to predict a power injection at a generator node of each inverter-based resource due to a disturbance, wherein the frequency model and the voltage model are solved independently to produce time-domain frequency and voltage trajectories for each inverter-based resource.
Clause 2. The method according to clause 1, wherein the frequency model is a first-order droop-based inverter frequency dynamics.
Clause 3. The method according to clause 1, wherein the frequency model is made by decoupling an active power flow from a reactive power flow.
Clause 4. The method according to clause 1, wherein the voltage model is made by coupling reactive power with active power.
Clause 5. The method according to clause 1, wherein the voltage model is solved by estimating a new active power injection based on the power injection at generator nodes of the plurality of inverter-based resources.
Clause 6. The method according to clause 5, wherein new reactive power at each generator node is calculated based on a change in an active power injection at each generator node, and wherein the change in reactive power injection is estimated between disturbance reactive injection before and after the disturbance.
Clause 7. The method according to clause 1, wherein the frequency model and the voltage model are solved using analytical matrix exponential solutions.
Clause 8. The method according to clause 1, wherein the network topology data is related to connections between load nodes and generator nodes via conducting buses.
Clause 9. The method according to clause 1, wherein the operating data includes a droop gain, a cut-off frequency, and a voltage angle, and a frequency.
Clause 10. The method according to clause 1, further comprising generating a control signal based on trajectories of the frequency dynamics and the change in the reactive power injection to adjust values of the operating data of power generators.
Clause 11. A grid monitoring system for fast and dynamic simulation of a power grid system, the grid monitoring system includes one or more processors; and a memory storing instructions that, when executed by the one or more processors, cause the grid monitoring system to: receive network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix; form a frequency model to predict frequency dynamics across the plurality of inverter-based resources based on the reduced susceptance matrix and the disturbance injection matrix; form a voltage model to track a change in a reactive power injection based on the reduced susceptance matrix and an angle of voltages at the plurality of inverter-based resources; and solve the frequency model and the voltage model to predict a power injection at a generator node of each inverter-based resource due to a disturbance, wherein the frequency model and the voltage model are solved independently to produce time-domain frequency and voltage trajectories for each inverter-based resource.
Clause 12. The grid monitoring system according to clause 11, wherein the frequency model is a first-order droop-based inverter frequency dynamics.
Clause 13. The grid monitoring system according to clause 11, wherein the frequency model is made by decoupling an active power flow from a reactive power flow.
Clause 14. The grid monitoring system according to clause 11, wherein the voltage model is made by coupling reactive power with active power.
Clause 15. The grid monitoring system according to clause 11, wherein the voltage model is solved by estimating a new active power injection based on the power injection at generator nodes of the plurality of inverter-based resources.
Clause 16. The grid monitoring system according to clause 15, wherein new reactive power at each generator node is calculated based on a change in an active power injection at each generator node, and wherein the change in reactive power injection is estimated between disturbance reactive injection before and after the disturbance.
Clause 17. The grid monitoring system according to clause 11, wherein the frequency model and the voltage model are solved using analytical matrix exponential solutions.
Clause 18. The grid monitoring system according to clause 11, wherein the network topology data is related to connections between load nodes and generator nodes via conducting buses.
Clause 19. The grid monitoring system according to clause 11, wherein the operating data includes a droop gain, a cut-off frequency, and a voltage angle, and a frequency.
Clause 20. A non-transitory computer-readable medium storing instructions that, when executed by one or more processors, cause the one or more processors to perform a method for monitoring a power grid system. The method includes receiving network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix; forming a frequency model to predict frequency dynamics across the plurality of inverter-based resources based on the reduced susceptance matrix and the disturbance injection matrix; forming a voltage model to track a change in a reactive power injection based on an AC power flow; and solving the frequency model and the voltage model to predict a power injection at a generator node of each inverter-based resource due to a disturbance. The frequency model and the voltage model are solved independently to produce time-domain frequency and voltage trajectories for each inverter-based resource.

The present disclosure may be embodied in other specific forms without departing from its spirit or essential characteristics. The described aspects are to be considered in all respects only as illustrative and not restrictive. The scope of the present disclosure is, therefore, indicated by the appended claims rather than by the foregoing description. All changes which come within the meaning and range of equivalency of the claims are to be embraced within their scope.

What is claimed is:

1. A method for monitoring a power grid system, comprising:
receiving network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix;
forming a frequency model to predict frequency dynamics across the plurality of inverter-based resources based on the reduced susceptance matrix and the disturbance injection matrix;
forming a voltage model to track a change in a reactive power injection based on an AC power flow; and
solving the frequency model and the voltage model to predict a power injection at a generator node of each inverter-based resource due to a disturbance,
wherein the frequency model and the voltage model are solved independently to produce time-domain frequency and voltage trajectories for each inverter-based resource.

2. The method according to claim 1, wherein the frequency model is a first-order droop-based inverter frequency dynamics.

3. The method according to claim 1, wherein the frequency model is made by decoupling an active power flow from a reactive power flow.

4. The method according to claim 1, wherein the voltage model is made by coupling reactive power with active power.

5. The method according to claim 1, wherein the voltage model is solved by estimating a new active power injection based on the power injection at generator nodes of the plurality of inverter-based resources.

6. The method according to claim 5, wherein new reactive power at each generator node is calculated based on a change in an active power injection at each generator node, and
wherein the change in reactive power injection is estimated between disturbance reactive injection before and after the disturbance.

7. The method according to claim 1, wherein the frequency model and the voltage model are solved using analytical matrix exponential solutions.

8. The method according to claim 1, wherein the network topology data is related to connections between load nodes and generator nodes via conducting buses.

9. The method according to claim 1, wherein the operating data includes a droop gain, a cut-off frequency, and a voltage angle, and a frequency.

10. The method according to claim 1, further comprising generating a control signal based on trajectories of the frequency dynamics and the change in the reactive power injection to adjust values of the operating data of power generators.

11. A grid monitoring system for fast and dynamic simulation of a power grid system, the grid monitoring system comprising:
one or more processors; and
a memory storing instructions that, when executed by the one or more processors, cause the grid monitoring system to:
receive network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix;
form a frequency model to predict frequency dynamics across the plurality of inverter-based resources based on the reduced susceptance matrix and the disturbance injection matrix;
form a voltage model to track a change in a reactive power injection based on an AC power flow; and
solve the frequency model and the voltage model to predict a power injection at a generator node of each inverter-based resource due to a disturbance,
wherein the frequency model and the voltage model are solved independently to produce time-domain frequency and voltage trajectories for each inverter-based resource.

12. The grid monitoring system according to claim 11, wherein the frequency model is a first-order droop-based inverter frequency dynamics.

13. The grid monitoring system according to claim 11, wherein the frequency model is made by decoupling an active power flow from a reactive power flow.

14. The grid monitoring system according to claim 11, wherein the voltage model is made by coupling reactive power with active power.

15. The grid monitoring system according to claim 11, wherein the voltage model is solved by estimating a new active power injection based on the power injection at generator nodes of the plurality of inverter-based resources.

16. The grid monitoring system according to claim 15, wherein new reactive power at each generator node is calculated based on a change in an active power injection at each generator node, and
wherein the change in reactive power injection is estimated between disturbance reactive injection before and after the disturbance.

17. The grid monitoring system according to claim 11, wherein the frequency model and the voltage model are solved using analytical matrix exponential solutions.

18. The grid monitoring system according to claim 11, wherein the network topology data is related to connections between load nodes and generator nodes via conducting buses.

19. The grid monitoring system according to claim 11, wherein the operating data includes a droop gain, a cut-off frequency, and a voltage angle, and a frequency.

20. A non-transitory computer-readable medium storing instructions that, when executed by one or more processors, cause the one or more processors to perform a method for monitoring a power grid system, the method comprising:
receiving network topology data and operating data of power generators and loads in the power grid system comprising a plurality of inverter-based resources, which are configured to operate in a grid-forming mode, to form a reduced susceptance matrix by eliminating non-generator nodes and a disturbance injection matrix;
forming a frequency model to predict frequency dynamics across the plurality of inverter-based resources based on the reduced susceptance matrix and the disturbance injection matrix;
forming a voltage model to track a change in a reactive power injection based on an AC power flow; and
solving the frequency model and the voltage model to predict a power injection at a generator node of each inverter-based resource due to a disturbance,
wherein the frequency model and the voltage model are solved independently to produce time-domain frequency and voltage trajectories for each inverter-based resource.
